(19) United States
(12) Patent Application Publication
(10) Pub. No.: US 2014/0188633 A1
(43) Pub. Date: Jul. 3, 2014

(54) Allocation of Content Inventory Units

(71) Applicant: Google Inc., Mountain View, CA (US)

(72) Inventors: Jacob P. Baskin, Brooklyn, NY (US); Samuel J. Felder, Brooklyn, NY (US)

(73) Assignee: Google Inc., Mountain View, CA (US)

(21) Appl. No.: 13/767,958

(22) Filed: Feb. 15, 2013

Related U.S. Application Data
(60) Provisional application No. 61/747,607, filed on Dec. 31, 2012.

(51) Int. Cl. G06Q 30/02

(52) U.S. Cl. CPC G06Q 30/0275
USPC 705/14.71

(57) ABSTRACT

This specification describes technologies relating to selection and delivery of online content. In general, one aspect of the subject matter described in this specification can be embodied in methods that include receiving data specifying a set of rules. A rule in the set of rules may include information identifying a set content inventory units and information specifying an action for controlling allocation of content inventory units. The methods may further include receiving a request for allocation of a content inventory unit, identifying a first rule in the set of rules that applies to the content inventory unit, and performing an action specified by the first rule for controlling the allocation of the content inventory unit. The methods may further include receiving bids and allocating the content inventory unit to a buyer based in part on the bids and a result of the action specified by the first rule.

### CROSS-REFERENCE TO RELATED APPLICATION

Priority is hereby claimed to U.S. Provisional Application No. 61/747,607, which was filed on Dec. 31, 2012. The contents of U.S. Provisional Application No. 61/747,607 are hereby incorporated by reference into this disclosure.

### BACKGROUND

This disclosure relates to the selection and delivery of online content.

Online content can include web pages and advertisements displayed with the web pages. Content publishers have space that they sell to advertisers or other content providers directly or through intermediaries, such as brokers. Some of a publisher's available space may be sold through a content inventory marketplace. This content inventory market is a spot market that connects publishers with content providers (e.g., advertisers) in response to a request for content from a user. The publisher may communicate with one or more content providers or market intermediaries in an attempt to sell the space in time to serve content associated with the buyer.

### SUMMARY

This specification describes technologies relating to selection and delivery of online content items. In general, one aspect of the subject matter described in this specification can be embodied in a method that includes receiving data specifying a set of rules associated with a publisher, where a rule in the set of rules may include information identifying a set content inventory units and information specifying an action for controlling allocation of content inventory units. The method may further include receiving a request for allocation of a content inventory unit associated with the publisher. The method may further include identifying a first rule in the set of rules that applies to the content inventory unit. The method may further include performing an action specified by the first rule using the one or more data processing apparatus, the action for controlling the allocation of the content inventory unit. The method may further include receiving one or more bids for the content inventory unit. The method may further include allocating the content inventory unit to a buyer based in part on the one or more bids and based in part on a result of the action specified by the first rule. The method may further include transmitting data reflecting the allocation of the content inventory unit in response to the request.

In general, one aspect of the subject matter described in this specification can be embodied in a system that includes an interface configured to receive data specifying a set of rules associated with a publisher, where a rule in the set of rules may include information identifying a set content inventory units and information specifying an action for controlling allocation of content inventory units. The system may include a network interface configured to receive a request for allocation of a content inventory unit associated with the publisher. The system may include a module configured to identify a first rule in the set of rules that applies to the content inventory unit. The system may include. The system may include a module configured to perform an action specified by the first rule using the one or more data processing apparatus, the action for controlling the allocation of the content inventory unit. The system may include a network interface configured to receive one or more bids for the content inventory unit. The system may include a module configured to allocate the content inventory unit to a buyer based in part on the one or more bids and based in part on a result of the action specified by the first rule. The system may include a network interface configured to transmit data reflecting the allocation of the content inventory unit in response to the request.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including receiving data specifying a set of rules associated with a publisher, where a rule in the set of rules may include information identifying a set content inventory units and information specifying an action for controlling allocation of content inventory units. The operations may further include receiving a request for allocation of a content inventory unit associated with the publisher. The operations may further include identifying a first rule in the set of rules that applies to the content inventory unit. The operations may further include performing an action specified by the first rule using the one or more data processing apparatus, the action for controlling the allocation of the content inventory unit. The operations may further include receiving one or more bids for the content inventory unit allocating the content inventory unit to a buyer based in part on the one or more bids and based in part on a result of the action specified by the first rule. The operations may further include. The operations may further include transmitting data reflecting the allocation of the content inventory unit in response to the request.

In general, one aspect of the subject matter described in this specification can be embodied in a non-transient computer readable media storing software including instructions executable by a processing device that upon such execution cause the processing device to perform operations that include receiving data specifying a set of rules associated with a publisher, where a rule in the set of rules may include information identifying a set content inventory units and information specifying an action for controlling allocation of content inventory units. The operations may further include receiving a request for allocation of a content inventory unit associated with the publisher. The operations may further include performing an action specified by the first rule using the one or more data processing apparatus, the action for controlling the allocation of the content inventory unit. The operations may further include identifying a first rule in the set of rules that applies to the content inventory unit. The operations may further include receiving one or more bids for the content inventory unit. The operations may further include allocating the content inventory unit to a buyer based in part on the one or more bids and based in part on a result of the action specified by the first rule. The operations may further include transmitting data reflecting the allocation of the content inventory unit in response to the request.

These and other embodiments can each optionally include one or more of the following features. The result of the action specified by the first rule may include a reserve price for an auction of the content inventory unit, where the reserve price is a minimum payment that a seller will accept for allocation of the content inventory unit. Participants in the auction of the content inventory unit may be informed of the identity of the publisher. The first rule may include information identifying a set of bids and the action specified by the first rule affects only bids in the set of bids. The result of the action specified by the first rule may include blocking one of the one or more bids. One or more additional rules may be identified in the set of rules that applies to the content inventory unit. One or more additional actions specified by the one or more additional rules may be performed for controlling the allocation of the content inventory unit. The content inventory unit may be allocated to the buyer based in part on a result of the one or more additional actions specified by the one or more additional rules. Rules in the set of rules may be respectively associated with a priority level. Identifying a first rule in the set of rules that applies to the content inventory unit may include checking rules in the rule set in an order determined by the respective priority levels associated with the rules to determine whether the rules apply to the content inventory unit. A log message recording the allocation of the content inventory unit may be generated, the log message indicating that the first rule was applied to allocate the content inventory unit. A message may be transmitted including a summary of revenues derived from a plurality of content inventory unit allocations that were based in part on a result of the action specified by the first rule. Information reflecting a content item supplied by the buyer may be transmitted to a user device.

Particular embodiments of the subject matter described in this disclosure can be implemented to realize none, one or more of the following advantages. Publishers may be enabled to efficiently manage large sets of online content slots using a rules based interface. Content inventory unit inventory may be allocated to a buyer that may enhance revenue for the publisher. In some implementations, adjustment of a set of rules to enhance revenue may be facilitated by providing feedback on the impact of individual rules on content inventory unit allocations.

The details of one or more embodiments of the subject matter described in this disclosure are set forth in the accompanying drawings and the description below. Other features, aspects, and advantages will become apparent from the description, the drawings, and the claims.

### BRIEF DESCRIPTION OF THE DRAWINGS

FIG. 1 is a block diagram of an example online environment.

FIG. 2 is block diagram of an example spot market for content inventory.

FIG. 3 is a flowchart of an example process for allocating a content inventory unit to a buyer in response to a user request for content.

FIG. 4 illustrates an example of an interface for specifying rules controlling allocation of content inventory units from the inventory of a publisher.

FIG. 5 is block diagram of an example computer system that can be used to facilitate the selection and delivery of content.

### DETAILED DESCRIPTION

Online content publishers try to derive as much revenue as they can from their available inventory (e.g., content slots in which advertisements or other content items may be presented). Publishers sell some of their inventory in guaranteed deals to individual content providers. The rest they generally provide to a number of different Market-Based Buyers (“MBBs”), who in turn sell to the highest bidder and pay the publisher some proportion of the received price. For example, MBBs can be yield managers or exchanges.

An example of a content inventory unit is a unit of content (e.g., ad) space inventory. For example, a content inventory unit occurs when an ad is delivered, usually with accompanying content, to a user. A content inventory unit may have a number of characteristics, such as characteristics of the requested content to be paired with the secondary content (e.g., ad), the timing of the user request and corresponding delivery of content, and characteristics of the user who requested the content, such as demographic information and geographic location. A single user request for content may initiate multiple content inventory units. For example, as user request for a web page may allow a publisher to deliver multiple ads that are displayed in different locations within the rendered web page. In some implementations, a system can record an indication of each delivered content inventory unit, such as for accounting purposes.

One type of MBB is an auction platform. An auction platform can allocate a content inventory unit in a content slot by accepting bids from one or more potential buyers (e.g., advertisers, advertising networks, or other demand-side platforms), selecting a winning bid, and determining a buyer's price for the content inventory unit based on an auction mechanism (e.g., a second-price auction mechanism).

When a publisher allocates a content inventory unit through an MBB (e.g., an auction platform) in a spot market for content inventory units, the allocation may be made based in part on one or more allocation control parameters specified by the publisher. For example, a publisher may specify a reserve price for a content inventory unit. The reserve price specified by a publisher may be the minimum amount of revenue that the publisher will accept in return for the allocation of the content inventory unit. If no bid exceeds the reserve price, then the content inventory unit may not be allocated through the auction platform (or equivalently, the content inventory unit is allocated back to the publisher). In some implementations, a publisher may specify an allocation control parameter called a block setting that prevents allocation of a content inventory unit to a particular buyer, group of buyers, or type of buyer. For example, a block setting may identify a particular advertiser or a particular advertising network from which bids for the content inventory unit will not be accepted. In some implementations, an allocation control parameter may restrict the type of bids that will be accepted based on properties of a content item associated with the bid. For example, an allocation control parameter may reject bids associated with content items that do not match a specified language, media type, or display parameter (e.g., display size or color scheme). In some implementations, multiple reserve prices may be specified for a content inventory unit. Each of the multiple reserve prices may apply to different sets of potential buyers.

Publishers may select different allocation control parameters for different content inventory units in their inventory. For example, allocation parameters may be specified for content inventory units based on which content slot the content inventory units occurs in (e.g., which webpage in a large website and/or where the content slot is located within a webpage), when the content inventory unit occurs, and/or information about a user requesting the content inventory unit (e.g., location or age).

Managing allocation control parameters for a large and varied set of content inventory unit inventory can become a complex task. In some implementations, a rules based interface is provided by an MBB (e.g., an auction platform) to publishers to allow a publisher to specify allocation control parameters for a large content inventory unit inventory. For example, a rule may identify a set of content inventory units to which the rule will apply and may also specify action for controlling allocation of content inventory units. In some implementations, a rule may also include information identifying a set of bids to which the rule will apply. For example, a rule may specify that for all content inventory units requested by users located in the United States, a reserve price of $2.50 will be used for all bids associated with advertisements from automobile manufacturer A or automobile manufacturer B.

Multiple rules may be specified by a publisher to manage the publisher's content inventory unit inventory. In some implementations, rules may also include a priority level, so that when two rules apply to a content inventory unit and their associated actions conflict, the higher priority rule is applied.

In some implementations, the application of rules during the allocation of content inventory units may be logged. Reports may be generated that summarize the impact of a rule on allocation of a publisher's content inventory unit inventory. The reports may provide feedback to a publisher to help them adjust their set of rules to achieve their content inventory unit allocation goals. For example, when a rule is applied to block a bid, that fact may be logged along with the resulting allocation, the price paid, and the amount of the blocked bid. For example, a report may be generated based on log messages that indicate this lost potential revenue associated with the rule.

A content item is any data that can be provided over a network. For example, an advertisement, including a link to a landing page is a content item. The processes described below are illustratively applied to content items that are advertisements provided in response to a request from an online resource, but the processes are also applicable to other content items provided over a network.

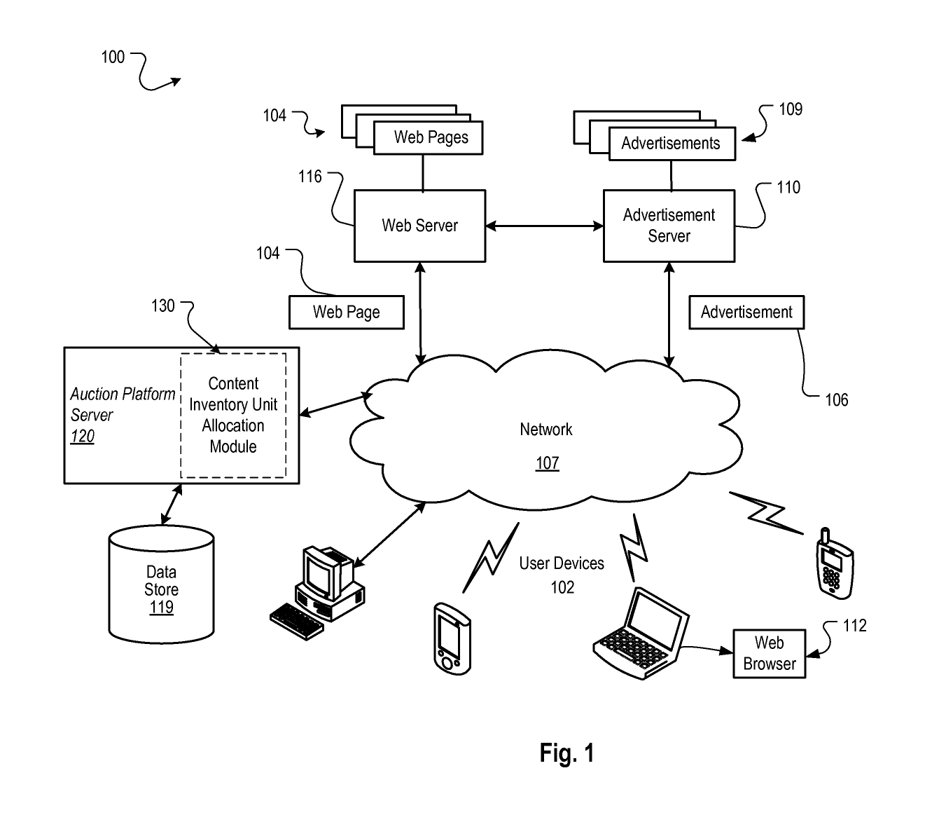

FIG. 1 is a block diagram of an example online environment 100 that enables the serving of content items for display on user devices 102. For example, content items can include web pages 104 and advertisements 106 (e.g., advertisements related to the web pages 104).

Web pages 104 and advertisements 106 can be provided to user devices 102 through a network 107 (e.g. a wide area network, local area network, the Internet, or any other public or private network, or combination of both.) User devices 102 can connect to a web server 116 (or an advertisement server 110) through the network 107 using any device capable of communicating in a computer network environment and displaying retrieved information. Example user devices 102 include a web-enabled handheld device, a mobile telephone or smartphone, tablet device, a set top box, a game console, a personal digital assistant, a navigation device, or a computer.

Web pages 104 can be provided by a web server 116 for display on a user device 102, and advertisements 106 can be provided by the advertisement server 110 for display on the user device 102. In some implementations, the advertisements 106 are provided directly to the web server 116 by the advertisement server 110, and the web server 116 then provides the advertisements 106 to the user devices 102 in association with one or more particular web pages 104, e.g., web pages which are related to the advertisements 106. In some implementations, the web server 116 queries the advertisement server 110 for advertisements 106 related to one or more particular web pages 104, and the advertisement server 110 evaluates a pool 109 of advertisements and chooses one or more advertisements 106 that are related to the web pages 104, e.g. advertisements that pertain to subject matter referenced by or described within the web pages 104. The advertisements 106 can be displayed with the web page 104 on a web browser 112 of a user device 102. The advertisements 106 can also be requested as part of the delivery of a web page 104 in response to a user device 102 requesting the web page 104 from a web server 116.

The content served by online publishers can take many other forms. For example, content items may include one or more media formats, including web pages, portions of web pages, banners, text, HTML page address pointers, hypertext, audio content, visual content, buttons, pop-up windows, placement within sponsored search listings, streaming media (including video and/or audio), and combinations thereof. Ads are content that advertisers may pay to have paired and delivered with other publisher content to users or consumers. Ads can be in any of the media formats that other content occurs in. While reference is made herein to the delivery of ads, other forms of content including other forms of sponsored content can be delivered by the systems and methods proposed.

When a user requests online content (e.g., a web page or another online resource), content requests can be initiated to request content from a content publisher for presentation on a user device. For example, content publishers can include publishers of web sites or search engines that are publishing search results responsive to a query. One or more additional content items (e.g., ads) can be provided along with the requested content. As a result, the presented content can include, for example, text, images, audio, video, advertisements (or ads) or other content selected for presentation to the user. In response to each content request received, content can be served, including one or more ads. Ads may advertise a product or service, on behalf of an advertiser, in a format that may entice an action (e.g., clicking, buying, etc.) by the user who sees the ad.

A publisher may operate a server, such as web server 116, for delivering content to users. The publisher may also operate an ad server, such as advertisement server 110, or may direct users to ads served from ad servers operated by other entities. When a publisher has content inventory, it often seeks to sell that inventory in real time on a spot market. For example, some of a publisher's inventory may be allocated through an auction platform. Webserver 116 may transmit a request that one of its content inventory units be allocated to auction platform server 120. Content inventory unit allocation module 130 may then run an auction to allocate the content inventory unit in accordance with the allocation control parameters specified by the publisher.

In some implementations, content inventory unit allocation module 130 determines allocation control parameters for a content inventory unit specified in a request for allocation by applying one or more rules from a set of rules previously specified by the publisher. For example, the rules may have been specified by the publisher or by another entity on the publisher's behalf through a rule-based allocation control interface provided by auction platform server 120. The set of rules may be stored in the data store 119. In some implementations, actions associated with one or more applicable rules are performed to determine the allocation control parameters for the request and allocate the content inventory unit. In some implementations, the resulting content inventory unit allocation may be logged along with information about which rule(s) were applied to the request and other associated data (e.g., bids received from potential buyers). For example, log messages may be stored in data store 119. In some implementations, reports may be generated summarizing the application of a rule to the inventory of a publisher and the impact of the rule. For example, a report for a publisher's rule(s) may be generated periodically or upon receipt of a request from the publisher.

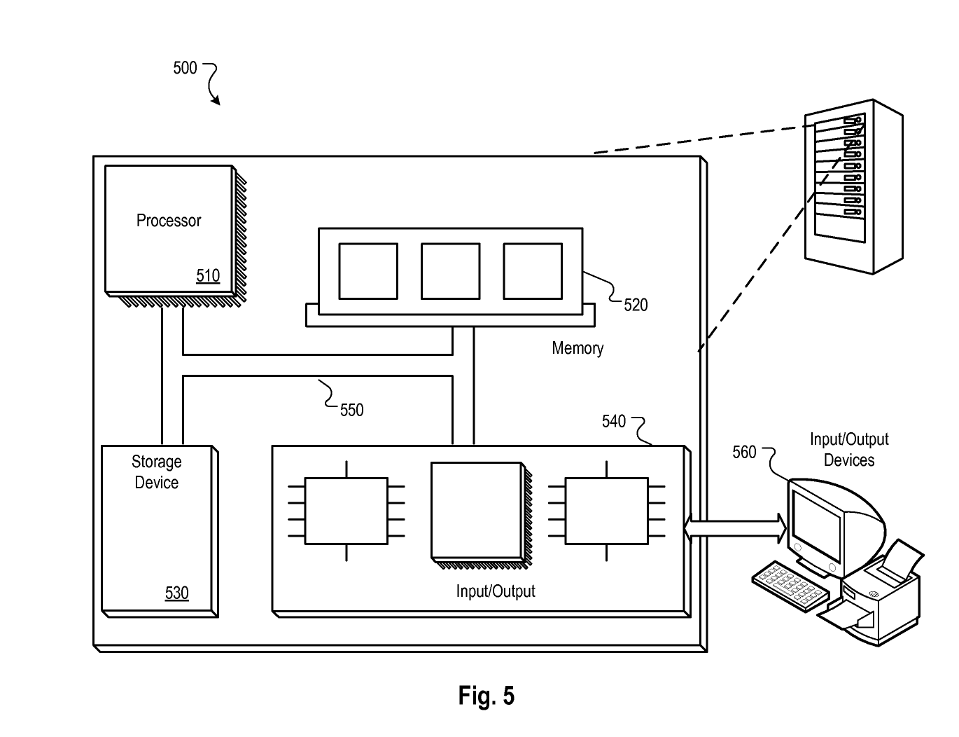

The content inventory unit allocation module 130 may be implemented in a variety of hardware and software configurations. For example, it may be implemented in software running on a dedicated processing system that is connected to a network, such as the Internet. The content inventory unit allocation module 130 may also be implemented in software that runs on a processing system utilized for other functionality, such as a web server 116 or an Ad server 110. In some implementations a content inventory unit allocation module 130 may run on a single processing device, such as the processing described below with reference to FIG. 5. In some implementations, a content inventory unit allocation module 130 may run on a on a multiple processing devices that communicate over a network and form a distributed computing system.

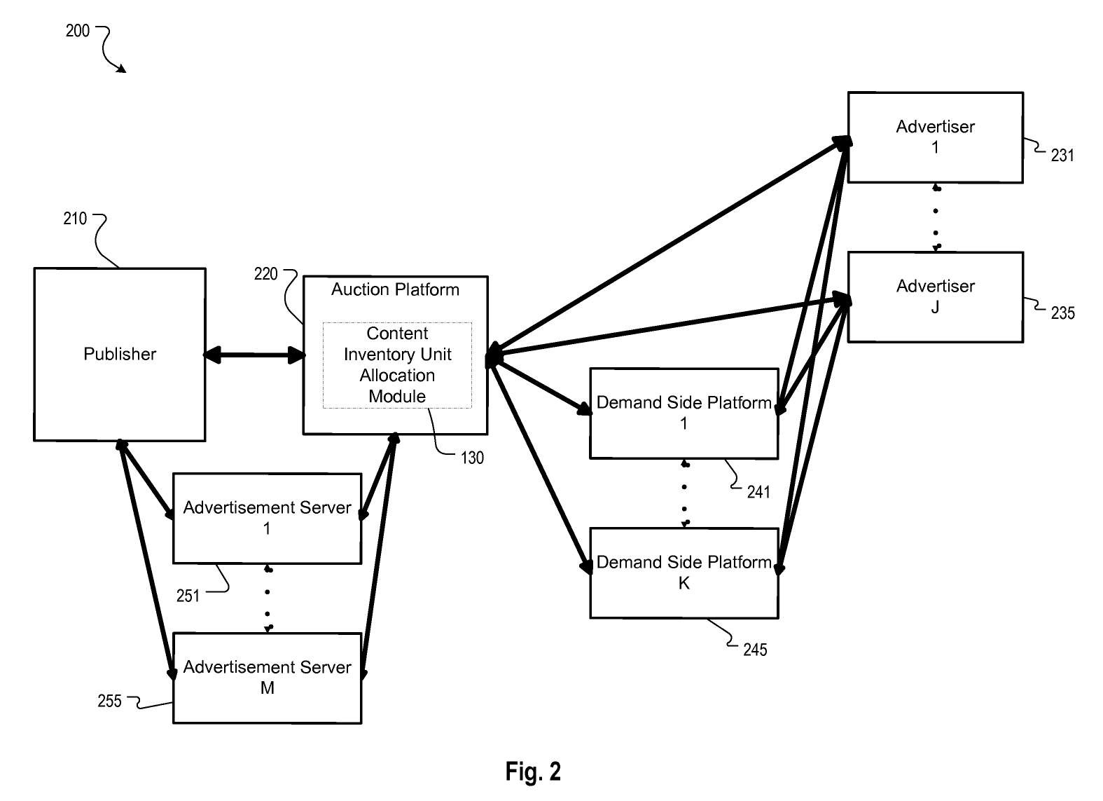

FIG. 2 is a block diagram of an example spot market for content inventory. The figure depicts the relationships between participants in the market. The lines in the figure represent transactions in which content inventory units are exchanged for content and revenue. Typically a content inventory unit, or information describing a content inventory unit, flows from left to right across the market via one or more transactions. In return, a content item (e.g., an ad), or information concerning a content item, that will be served in the content inventory unit and revenue flow back to the publisher via the same transaction pathway.

A publisher 210 sells content inventory units to buyers. Usually, the publisher 210 allocates a content inventory unit through an MBB, such as auction platform 220. The MBB in turn sells the content inventory unit to a content provider (e.g., Advertiser 231 or 235) either directly or through another intermediary, such as a Demand-Side Platform (“DSP”) (e.g., DSP 241 or DSP 245). Content networks may act as DSPs in some implementations. Publisher 210 may interface directly with an MBB (e.g., auction platform 220) to allocate content inventory units. In some implementations, a publisher may use one or more advertisement servers (e.g., advertisement server 251 or advertisement server 255) to manage its content inventory unit inventory. For example, advertisement server 251 may allocate content inventory units for publisher 210 and occasionally send a request for allocation of inventory to auction platform 220.

An MBB can conduct an auction for the content inventory unit, selling the content inventory unit to, for example, the highest bidder. The auction platform 220, for example, then provides a portion of the revenues from the sale to the publisher 210. The advertiser 231, for example, that ultimately buys the content inventory unit, gets to have one of its ads served or delivered to the user in the content inventory unit.

The auction platform 220 may use a content inventory unit allocation module 130 to implement an auction mechanism and allocate the content inventory unit in accordance with rules specified by the publisher to control allocation of the publisher's content inventory unit inventory. For example, content inventory unit allocation module 130 may run an auction for the content inventory unit with a reserve price determined based on a rule that is applicable to the content inventory unit. In some implementations, an applicable rule may cause the content inventory unit allocation module 130 to reject bids from certain potential buyers (e.g., advertiser 231 or demand side platform 241) to effectively block allocation of the content inventory unit to or through those potential buyers. The rules controlling allocation of a publisher's inventory may be specified by communications from publisher 210 to auction platform 220 through a rule based content inventory unit allocation control interface.

The content inventory unit allocation module 130 may record data regarding the transaction for accounting purposes or for logging the application and impact or rules. The information saved may include identification of an applied rule, resulting allocation control parameters (e.g., a reserve price or a block setting), the bids received, an identification of the buyer, and/or information about the content inventory unit, such as an identification of the content slot and the publisher, the time, or user characteristics. This transaction data may be stored directly in a record associated with a particular publisher or a particular rule for the publisher. In some implementations, the information may be stored in a log of transactions that is processed periodically to update reports regarding application and impact of rules specified by a publisher.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

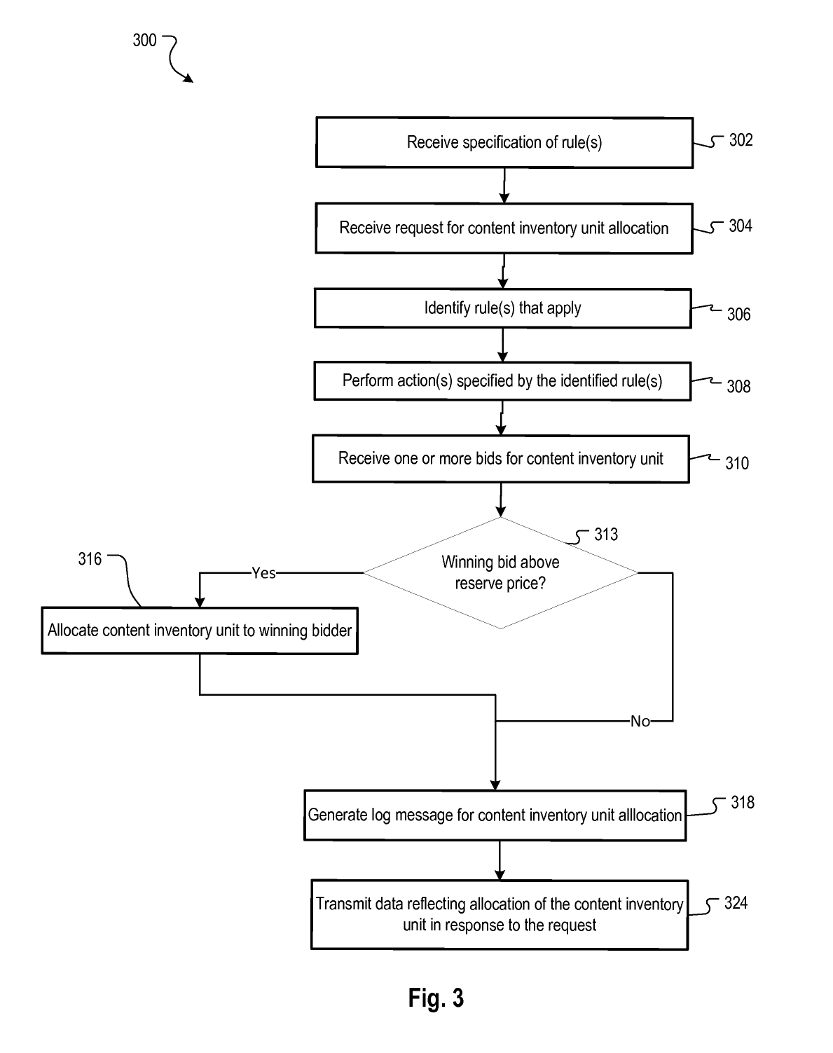

FIG. 3 is a flow chart of an example process 300 for allocating a content inventory unit to a buyer in response to a request. The content inventory unit allocation process 300 may be performed, for example, by the content inventory unit allocation module 130 of auction platform server 120.

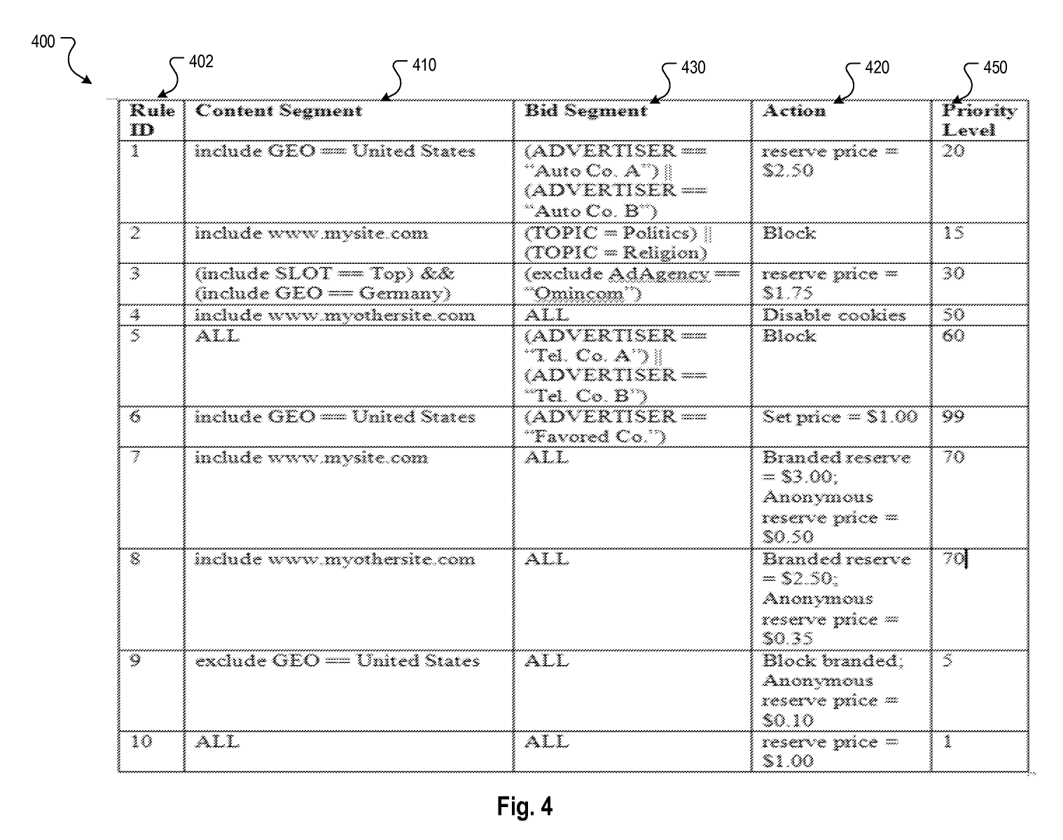

Process 300 may include receiving (302) a specification of one or more rules for controlling allocation of content inventory units in the inventory of a publisher. The rules may be part of a set of rules controlling allocation of content inventory units for the publisher. A rule in the set may include information identifying a set content inventory units and information specifying an action for controlling allocation of content inventory units. A publisher may specify rules using a rule based content inventory unit allocation control interface provided by an MBB (e.g., auction platform 220). In some implementations, the interface 400 illustrated in FIG. 4 may be used to specify the rule(s). In some implementations, the publisher or another entity access a remote server to access the rule based content inventory unit allocation control interface and configure one or more rules on behalf of the publisher. The remote server may encode the rules based on this interaction and transmit them another server operated by an MBB that will apply the rules to allocate content inventory units. For example, the specification of the rule(s) may be received (302) through a network interface of the auction platform server 120.

After the rule(s) have been specified, the MBB (e.g., auction platform 120) receives (304) a request for allocation of a content inventory unit from the inventory of the publisher. For example, the request for content inventory unit allocation may be received from a publisher (e.g., web server 116 or publisher 210). In other examples, the request may be received from an advertisement management system (e.g., advertisement server 110), or directly from a user device (e.g., user device 102 running web browser 112) requesting content including the content inventory unit, among other possible sources. The process 300 may be performed for each content inventory unit implicated by a user request for content. For example, the request may be received (304) through a network interface of the auction platform server 120.

One or more rules from the set of rules for the publisher may be identified (306) as applying to the request. Information identifying a set of content inventory units for a rule may be compared to information from the request that reflects characteristics of the content inventory unit that will be allocated. If the information identifying the set of content inventory units matches the information for the requested content inventory unit, then the rule may be identified (306) as applicable to the content inventory unit. For example, information identifying the set of content inventory units may include a uniform resource locator (URL). Publishers specify domains and/or paths in which content slots for the set of content inventory units occur. If the request is for a content inventory unit in a content slot with a domain and/or path matching the URL, then the rule may be identified (306) as applicable.

In some implementations, the information identifying the set of content inventory units associated with the rule may include a geographic location (e.g., a country or a particular latitude and longitude range) of a user requesting the content inventory units. If information, obtained with user permission, about the geographic location of a user associated with the current requested content inventory unit matches the geographic locations specified for the set of content inventory units, then the rule may be identified (306) as applicable.

In some implementations, the information identifying the set of content inventory units may include a time range (e.g., a date and/or a time of day) of content inventory units in the set. If the time associated with the current requested content inventory unit matches the time range for content inventory units in the set, then the rule may be identified (306) as applicable.

In some implementations, the information identifying the set of content inventory units in the rule may include a format parameter for a content slot (e.g., a size of content slot within a display or an allowed duration for a video or audio content item) for the content inventory units. If information about the format of a content slot associated with the current requested content inventory unit matches the format target for subject content inventory units, then the rule may be identified (306) as applicable.

In some implementations, the information identifying the set of content inventory units associated with the rule may include a content inventory unit tag (e.g., a label from a publisher's inventory hierarchy or a third party inventory hierarchy). If a tag associated with the current requested content inventory unit matches the tag specified for content inventory units associated with the rule, then the rule may be identified (306) as applicable.

Information describing many other characteristics of content inventory units may be compared to corresponding characteristics for the currently requested content inventory unit to identify (306) applicable rules. In some implementations, the information identifying content inventory units is specified as an exclusion. For example, the set of content inventory units associated with a rule may include all content inventory units of the publisher except for content inventory units in content slots matching a specified URL. In some implementations, content inventory units may be identified by a logical expression including conditions on multiple characteristics of the content inventory units. For example, a publisher may specify that the set of content inventory units includes content inventory units that are to be viewed in the United States, but excluding content inventory units in content slots within a certain URL using an expression with syntax similar to:
(include GEO==United States) && (exclude www.foo.com),
   where “include” is a keyword indicating that content inventory units matching the following characteristic are included in the set of subject content inventory units, “exclude” is a keyword indicating that content inventory units matching the following characteristic are not included in the set of subject content inventory units, “GEO” is a keyword reference a geographic location characteristic of a content inventory unit, “United States” is particular value of the geographic location characteristic corresponding to a location in the country, “www.foo.com” is a URL value, and “==” and “&&” are Boolean operators.

In some implementations, rules in the set of rules for the publisher may include respective priority levels. For example, priority levels for each rule may be specified by the publisher. In some implementations, the information identifying subject content inventory units for rules are compared to the corresponding information for the currently requested content inventory unit in an order that depends on the priority levels of the rules. For example, higher priority rules may be tested first and only the highest priority rule matching the currently requested content inventory unit may be identified (306) as applicable. In some implementations, all of the rules are tested against the characteristics of the currently requested content inventory unit and all of the rules matching the characteristics of the currently requested content inventory unit may be identified (306) as applicable, unless a conflict is detected between the actions associated with two applicable rules. When a conflict is detected between the actions for two rules, the conflict may be resolved by identifying (306) only the higher priority rule as applicable and designating any lower priority conflicting rules as not applicable.

The applicable rule(s) may be identified (306) in real-time in response to the request for allocation of the content inventory unit. For example, the applicable rule(s) may be identified (306) by the content inventory unit allocation module 130 of the auction platform server 120.

One or more actions may be performed (308), where the action(s) are specified by the applicable rule(s). In some implementations, performing an action for a rule includes generating (e.g., setting or updating) a content inventory unit allocation control parameter (e.g., a reserve price or a block setting) that will be used to allocate the request.

In some implementations, a rule includes information identifying a set of bids and the action specified by the rule affects only bids in the set of bids. Information identifying a set of bids for a rule may be compared to information from received bids or information about potential buyers for the current content inventory unit. If the information identifying the set of bids matches the information for a received bud or potential buyer, then the action for the rule may be performed (308) to process the received bid or interact with the potential buyer. For example, the information identifying a set of bids may include a specification of a potential buyer (e.g., an advertiser, an advertisement agency, and advertisement network, or another demand side platform) and the action for the rule may include offering the content inventory unit to the potential buyer before auction at a set price. Performing (308) the action may include transmitting an auction announcement message to the specified potential buyer that presents the option of purchase of the content inventory unit for a set price (e.g., a set price higher than the reserve price that will be used in an auction if the option is declined by the specified potential buyer).

In some implementations, a reserve price is specified that is applicable only to one or more potential buyers in a specified subset of potential buyers. In some implementations, a branded reserve price and/or an anonymous reserve price may be set for use with bids from all potential buyers or only with bids from buyers in a specified subset. A branded reserve price is a reserve price used with a bid made by a potential buyer that is informed of the identity of the publisher that is selling the content inventory unit. An anonymous reserve price is a reserve price used with a bid made by a potential buyer that is not informed of the identity of the publisher that is selling the content inventory unit.

In some implementations, a reserve price is specified for use only with bids in a set of bids, where the set of bids is associated with content items with particular characteristics. For example, different reserve prices may be determined for bids associated with text advertisements versus bids associated with video advertisements.

Rules that specify content inventory unit pricing control parameters (e.g., set prices or reserve prices) may conflict with one another. Conflicting rules may be resolved by comparing the priority levels assigned to each of the conflicting rules and only performing the action of the highest priority rule from among the conflicting rules. In some implementations, a default pricing rule may be specified that determines any required pricing control parameter (e.g., a reserve price) when no other pricing rule applies. For example, a default pricing rule may be assigned the lowest priority level.

The result of an action specified by a first rule may include blocking (e.g., preventing, rejecting, or ignoring) one or more bids. In some implementations, performing (308) an action for a rule may include generating a block setting and enforcing that block setting.

For example, the actions for applicable rule(s) may be performed (308) by the content inventory unit allocation module 130 of the auction platform server 120.

One or more bids for the content inventory unit may be received (310) from prospective buyers (e.g., advertiser 231 or demand side platform 241). In some implementations, prospective buyers submit bids in response to auction announcement message from the auction platform 220. In some implementations, the auction announcement message includes an indication of a reserve price. In some implementations, a block setting may be enforced in part by not transmitting an auction announcement message to a potential buyer identified by the block setting. In some implementations, a block setting is enforced by rejecting or ignoring a received bid that is identified as a member of a set of bids specified by rule that generates the block setting. For example, the bids may be received (310) through a network interface of the auction platform server 120.

One or more of the bids may be compared to a reserve price generated based on an applicable rule. For example, a highest bid may be compared to a reserve price to determine whether the content inventory unit will be allocated to a buyer by the auction platform. In some implementations, a second highest bid is compared to the applicable reserve price to determine the price that will be paid by the winning bidder, e.g., the buyer that submitted the highest bid.

If the winning bid is greater than the applicable reserve price (313), then the content inventory unit is allocated (316) to the buyer that submitted the winning bid. A content item (e.g., an advertisement) from the buyer (e.g., advertiser 231) or a subsequent purchaser will be served as the content inventory unit and, in exchange, the buyer will pay a price that may depend on the bids and/or the applicable reserve price. Data reflecting the allocation of the content inventory unit to the buyer and the price may be generated and stored in a data storage device (e.g., data store 119). For example, the content inventory unit may be allocated (316) to a buyer by the content inventory unit allocation module 130 of the auction platform server 120.

A log message may be generated (318) that reflects the allocation of the content inventory unit. The log message may include information identifying the one or more applicable rules that impacted the content inventory unit allocation. For example, the log message may include an identification of each rule for which the corresponding action was performed during content inventory unit allocation process 300, a record of the result of the action (e.g., a reserve price, a set price, or a block setting), a record of the received bids, and/or a record of the final allocation to a buyer with the price paid for the content inventory unit. In some implementations, only a single pricing rule (e.g., the highest priority applicable pricing rule) is logged as active for a given request. For example, the log message may be stored in data store 119. In some implementations, the information in a log message may be used to update an allocation impact record for a rule in the set of rules for the publisher.

In some implementations, a message including a summary of revenues derived from a plurality of content inventory unit allocations that were based in part on a result of the action specified in a particular rule in the set of rules for a publisher is transmitted to the publisher. This report may facilitate tuning or adjustment of the rule or the set of rules by the publisher to achieve goals such as increasing average revenue generated from the publisher's inventory. For example, messages including summary reports for a rule may be transmitted periodically (e.g., once a day, week, or month), upon receipt of a request for the report from the publisher, or after each new log message is generated that identifies the rule in question. For example, data reflecting the allocation of the content inventory unit to the buyer may be transmitted through a network interface of the auction platform server 120.

Data reflecting the allocation of the content inventory unit to the buyer in response to the request may be transmitted (324). For example the data reflecting the allocation may be transmitted to the buyer (e.g., advertiser 231), the publisher (e.g., publisher 210 and/or webserver 116), and/or a user device (e.g., user device 102 running web browser 112). The data reflecting the allocation may include information identifying the buyer and the content inventory unit. In some implementations, the data reflecting the allocation may also include the price paid by the buyer, the revenue received by the seller, characteristics of the content inventory unit, and/or a content item that will be presented in the content inventory unit as a result of the allocation.

In some implementations, information reflecting a content item supplied by the buyer is transmitted to a user device. In some implementations, the content item may be transmitted to the publisher who then relays the content to a user device. In some implementations, the publisher may only receive and relay a pointer to the content item, such as an address for the content item stored on a remote server run by the advertiser or another entity. In some implementations, an external device storing the content item may independently establish a communication with the user's access device based upon information supplied by the publisher with the description of the content inventory unit. Data reflecting the allocation of the content inventory unit may be transmitted in one or more messages over a network (e.g., network 107). For example, data reflecting the identification of the content inventory unit and the price to be paid by the buyer may be transmitted in a first message to the buyer, while data reflecting the revenues paid to the seller may be transmitted to the seller. For example, data reflecting the allocation of the content inventory unit to the buyer may be transmitted (324) through a network interface of the auction platform 220.

If the winning adjusted bid is less than the applicable reserve price (313), then the next highest bid (if any) with a different applicable reserve price may be checked against its respective reserve price. If the next highest bid is greater than its respective reserve price (313), then this bid is the winning bid and the content inventory unit is allocated (316) to the buyer that submitted this bid.

If none of the bids is above their respective applicable reserve prices (313), then the content inventory unit is not allocated to a buyer. Equivalently, the content inventory unit is allocated back to the seller (e.g., publisher 210). This result may be reflected in data transmitted (324) by auction platform through a network interface to inform the seller and/or any potential buyers that submitted bids. A log message may also be generated (318) that reflects that the content inventory unit was not successfully allocated through the MBB (e.g., auction platform 220). The log message may include information identifying the one or more applicable rules that impacted the content inventory unit allocation. For example, the log message may include an identification of each rule for which the corresponding action was performed during content inventory unit allocation process 300, a record of the result of the action (e.g., a reserve price, a set price, or a block setting), and/or a record of the received bids. In some implementations, only a single pricing rule (e.g., the highest priority applicable pricing rule) is logged as active for a given request. For example, the log message may be stored in data store 119. In some implementations, the information in a log message may be used to update an allocation impact record for a rule in the set of rules for the publisher.

FIG. 4 illustrates an example of an interface 400 for specifying rules controlling allocation of content inventory units from the inventory of a publisher. For example, interface 400 may be encoded and served by an MBB sever, e.g., auction platform server 120. For example, interface 400 may be presented to user specifying the rules on behalf of a publisher through a display on a user device (e.g., user device 102). The user's interactions with the interface 400 may be encoded and transmitted back to the MBB providing the interface 400 (e.g., auction platform server 120). In some implementations, the user interactions with interface 400 may be interpreted and/or compiled to generate executable rules in set of rules controlling allocation of content inventory units from the inventory of the publisher.

The interface 400 allows a user to specify one or more rules (e.g., corresponding to rows in the illustration). Each rule may have a rule identifier 402 that facilitates reference to the rule (e.g., in stored rule impact report records). In some implementations, a formatted string may be entered to specify a “content segment” 410 (e.g., a set of content inventory units) to which the rule will apply. For example, the formatted string may include keywords that facilitate reference to content inventory unit characteristics (e.g., “GEO” for a geographic location associate with the request for the content inventory unit and “SLOT” for content slot properties such size or location within a web page). The formatted strings may also include reserved operators (e.g., “include”, “exclude”, and Boolean operators such as “==”, “&&” and “∥”) that enable specification of a logical statement identifying content inventory units in a set of content inventory units. The formatted strings may also include defined constants (e.g., “United States” and “Germany” representing locations in particular countries and “ALL” representing all content inventory unit in the inventory of the publisher). Other text strings may be included in the formatted string to specify a value of a content inventory unit characteristic, such as a URL for content inventory unit in a set of content inventory units.

In some implementations, a formatted string may be entered to specify an “action” 420 (e.g., generating a reserve price, a set price, or a blocking setting) that may be performed on content inventory units to which the rule applies. For example, the formatted string may include keywords that enable reference to allocation control parameters for a content inventory unit (e.g., “reserve price” for a reserve price that may be used in an auction of the content inventory unit, “Set price” for a set price that is presented as an option to a specified buyer before an auction, “Branded reserve” for a reserve price that is used in auctions for bids from potential buyers that have been informed of the identity of the publisher, “Anonymous reserve price” for a reserve price that is used in auctions for bids from potential buyers that have not been informed of the identity of the publisher, “Block” for causing a block setting to be generated, and “Disable Cookies” for causing restrictions to be enforced on a buyer of the content inventory unit for how Cookies from an end user that requested the content inventory unit may be handled). The formatted strings may also include reserved operators (e.g., “=”) that facilitate specification of a particular value for a content inventory unit allocation control parameter. Other text strings may be included in the formatted string to specify a value of a content inventory unit allocation control parameter, such as a currency amount for a price (e.g., a reserve price or a set price).

In some implementations, a formatted string may be entered to specify a “bid segment” 430 (e.g., a set of bids) to which the rule will apply. For example, the formatted string may include keywords that enable reference to bid characteristics (e.g., “ADVERTISER” for identifying of a particular advertiser associated with a bid, “AdAgency” for identifying of a particular advertising agency associated with a bid, and “TOPIC” for identifying a particular topic that has been determined to be relevant to a content item associated with a bid). The formatted strings may also include reserved operators (e.g., “include”, “exclude”, and Boolean operators such as “==”, “&&” and “∥”) that facilitate specification of a logical statement identifying bids in a set of bids. The formatted strings may also include defined constants (e.g., “Politics” and “Religion” representing particular topics determined to be relevant to a content item associated with a bid, and “ALL” representing all bids and/or potential buyers for a content inventory unit). Other text strings may be included in the formatted string to specify a value of a content inventory unit characteristic, such as a company name for an advertiser associated with a bid.

In some implementations, interface 400 may enable the specification of a priority level 450 for each rule in a set of rules for a publisher. Rules with higher values for their priority level, may take override a conflicting action for another rule with a lower priority level. For example, rule 10 in FIG. 4 is a default pricing rule that applies to “ALL” of the content inventory units in the inventory of the publisher and to “ALL” bids for such content inventory units. The default pricing rule has been assigned a low priority level (e.g., 1) so that it may be overridden when another conflicting pricing rule applies. For example, when a request is received for allocation of a content inventory unit in a content slot in the website accessed at the URL www.mysite.com, rule 7, which has a higher priority level of 70, will apply and generate a branded reserve price of $3.00 and an anonymous reserve price of $0.50, while default rule 10 will be overridden. For this example set of rules, because the default rule 10 has the lowest priority level, default pricing rule 10 may only be applied to requests for allocation for which no other conflicting pricing rules apply.

FIG. 5 is block diagram of an example computer system 500 that can be used to allocate content inventory units. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 560.

The web server, advertisement server, and content inventory unit allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any claims or of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method performed by one or more data processing apparatus, the method comprising:
receiving data specifying a set of rules associated with a publisher, where a rule in the set of rules comprises information identifying a set content inventory units and information specifying an action for controlling allocation of content inventory units;
receiving a request for allocation of a content inventory unit associated with the publisher;
identifying a first rule in the set of rules that applies to the content inventory unit;
performing an action specified by the first rule using the one or more data processing apparatus, the action for controlling the allocation of the content inventory unit;
receiving one or more bids for the content inventory unit;
allocating the content inventory unit to a buyer based in part on the one or more bids and based in part on a result of the action specified by the first rule; and
transmitting data reflecting the allocation of the content inventory unit in response to the request.

2. The method of claim 1, in which the result of the action specified by the first rule comprises a reserve price for an auction of the content inventory unit, where the reserve price is a minimum payment that a seller will accept for allocation of the content inventory unit.

3. The method of claim 2, in which participants in the auction of the content inventory unit are informed of the identity of the publisher.

4. The method of claim 1, in which the first rule further comprises information identifying a set of bids and the action specified by the first rule affects only bids in the set of bids.

5. The method of claim 4, in which the result of the action specified by the first rule comprises blocking one of the one or more bids.

6. The method of claim 1, further comprising:
identifying one or more additional rules in the set of rules that applies to the content inventory unit;
performing one or more additional actions specified by the one or more additional rules for controlling the allocation of the content inventory unit; and
allocating the content inventory unit to the buyer based in part on a result of the one or more additional actions specified by the one or more additional rules.

7. The method of claim 1, in which rules in the set of rules are respectively associated with a priority level; and identifying a first rule in the set of rules that applies to the content inventory unit comprises:
checking rules in the rule set in an order determined by the respective priority levels associated with the rules to determine whether the rules apply to the content inventory unit.

8. The method of claim 1, further comprising:
generating a log message recording the allocation of the content inventory unit, the log message indicating that the first rule was applied to allocate the content inventory unit.

9. The method of claim 1, further comprising:
transmitting a message including a summary of revenues derived from a plurality of content inventory unit allocations that were based in part on a result of the action specified by the first rule.

10. The method of claim 1, further comprising:
transmitting to a user device information reflecting a content item supplied by the buyer.

11. A system, comprising:
a data processing apparatus; and
a memory coupled to the data processing apparatus having instructions stored thereon which, when executed by the data processing apparatus cause the data processing apparatus to perform operations comprising:
receiving data specifying a set of rules associated with a publisher, where a rule in the set of rules comprises information identifying a set content inventory units and information specifying an action for controlling allocation of content inventory units;
receiving a request for allocation of a content inventory unit associated with the publisher;
identifying a first rule in the set of rules that applies to the content inventory unit;
performing an action specified by the first rule using the one or more data processing apparatus, the action for controlling the allocation of the content inventory unit;
receiving one or more bids for the content inventory unit;
allocating the content inventory unit to a buyer based in part on the one or more bids and based in part on a result of the action specified by the first rule; and
transmitting data reflecting the allocation of the content inventory unit in response to the request.

12. The system of claim 11, in which the result of the action specified by the first rule comprises a reserve price for an auction of the content inventory unit, where the reserve price is a minimum payment that a seller will accept for allocation of the content inventory unit.

13. The system of claim 12, in which participants in the auction of the content inventory unit are informed of the identity of the publisher.

14. The system of claim 11, in which the first rule further comprises information identifying a set of bids and the action specified by the first rule affects only bids in the set of bids.

15. The system of claim 14, in which the result of the action specified by the first rule comprises blocking one of the one or more bids.

16. The system of claim 11, in which the operations further comprise
identifying one or more additional rules in the set of rules that applies to the content inventory unit;
performing one or more additional actions specified by the one or more additional rules for controlling the allocation of the content inventory unit; and
allocating the content inventory unit to the buyer based in part on a result of the one or more additional actions specified by the one or more additional rules.

17. The system of claim 11, in which rules in the set of rules are respectively associated with a priority level; and identifying a first rule in the set of rules that applies to the content inventory unit comprises:
checking rules in the rule set in an order determined by the respective priority levels associated with the rules to determine whether the rules apply to the content inventory unit.

18. The system of claim 11, in which the operations further comprise
generating a log message recording the allocation of the content inventory unit, the log message indicating that the first rule was applied to allocate the content inventory unit.

19. The system of claim 11, in which the operations further comprise
transmitting a message including a summary of revenues derived from a plurality of content inventory unit allocations that were based in part on a result of the action specified by the first rule.

20. The system of claim 11, in which the operations further comprise
transmitting to a user device information reflecting a content item supplied by the buyer.

21. A system comprising:
an interface configured to receive data specifying a set of rules associated with a publisher, where a rule in the set of rules comprises information identifying a set content inventory units and information specifying an action for controlling allocation of content inventory units;
a network interface configured to receive a request for allocation of a content inventory unit associated with the publisher;
a module configured to identify a first rule in the set of rules that applies to the content inventory unit;
a module configured to perform an action specified by the first rule using the one or more data processing apparatus, the action for controlling the allocation of the content inventory unit;
a network interface configured to receive one or more bids for the content inventory unit;
a module configured to allocate the content inventory unit to a buyer based in part on the one or more bids and based in part on a result of the action specified by the first rule; and
a network interface configured to transmit data reflecting the allocation of the content inventory unit in response to the request.

22. The system of claim 21, in which the result of the action specified by the first rule comprises a reserve price for an auction of the content inventory unit, where the reserve price is a minimum payment that a seller will accept for allocation of the content inventory unit.

23. The system of claim 22, in which participants in the auction of the content inventory unit are informed of the identity of the publisher.

24. The system of claim 21, in which the first rule further comprises information identifying a set of bids and the action specified by the first rule affects only bids in the set of bids.

25. The system of claim 24, in which the result of the action specified by the first rule comprises blocking one of the one or more bids.

26. The system of claim 21, comprising:
a module configured to identify one or more additional rules in the set of rules that applies to the content inventory unit;
a module configured to perform one or more additional actions specified by the one or more additional rules for controlling the allocation of the content inventory unit; and
a module configured to allocate the content inventory unit to the buyer based in part on a result of the one or more additional actions specified by the one or more additional rules.

27. The system of claim 21, in which rules in the set of rules are respectively associated with a priority level; and identifying a first rule in the set of rules that applies to the content inventory unit comprises:
checking rules in the rule set in an order determined by the respective priority levels associated with the rules to determine whether the rules apply to the content inventory unit.

28. The system of claim 21, comprising:
a module configured to generate a log message recording the allocation of the content inventory unit, the log message indicating that the first rule was applied to allocate the content inventory unit.

29. The system of claim 21, comprising:
a network interface configured to transmit a message including a summary of revenues derived from a plurality of content inventory unit allocations that were based in part on a result of the action specified by the first rule.

30. The system of claim 21, comprising:
a network interface configured to transmit to a user device information reflecting a content item supplied by the buyer.
